(19) United States
(12) Patent Application Publication
(10) Pub. No.: US 2003/0040757 A1
(43) Pub. Date: Feb. 27, 2003

(54) System, method and apparatus for the localization of instruments inside the body

(76) Inventor: Ronit Argaman, Hod Hasharon (IL)

Correspondence Address: Eitan, Pearl, Latzer & Cohen Zedek, LLP., Suite 1001, 10 Rockefeller Plaza, New York, NY, 10020, US

(21) Appl. No.: 10/213,450

(22) Filed: Aug. 7, 2002

Related U.S. Application Data
(60) Provisional application No. 60/310,234, filed on Aug. 7, 2001.

(51) Int. Cl. A61D 1/04

(52) U.S. Cl. 606/116

(57) ABSTRACT

A marker for attaching to, and marking a medical treatment device to be inserted inside a patient's body, the marker including one or more sealed cells.

The present application claims priority from U.S. Provisional Application Serial No. 60/310,234, filed Aug. 7, 2001, and entitled “A SYSTEM, METHOD AND APPARATUS FOR THE LOCALIZATION OF INSTRUMENTS INSIDE THE BODY”.

### FIELD OF THE INVENTION

The present invention generally relates to the field of invasive medical procedures, and more specifically the present invention relates to the localization of medical treatment devices inside a patient's body.

### BACKGROUND OF THE INVENTION

In recent years there has been a significant increase in micro medical procedures. Such procedures are typically of a minimally invasive nature, wherein a medical treatment device is inserted into the body of a patient through a small incision to deliver a focused treatment to a well-defined target area. The use of micro medical procedures has various clinical advantages, such as reduction of collateral damage to healthy tissue, reduction of patient trauma and shorter recovery periods.

In some invasive procedures, it is difficult to determine the location of the treatment device being used or the path of the treatment device within the patient's body, for example, optical fibers may not be visible using ultra-sound detection.

### SUMMARY OF THE INVENTION

According to an embodiment of the present invention, a marker for marking a medical treatment device to be inserted inside a patient's body may include one or more sealed cells or cavities, each cell may be attachable to one or more portions of the medical treatment device.

According to a further embodiment of the present invention each one of the one or more sealed cells or cavities may contain a volume of gas.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1A is a block diagram illustration of a medical treatment device coupled with one or more markers, according to some embodiments of the present invention;

FIG. 1B is a close up view of the marker of FIG. 1A;

FIG. 2 is a block diagram illustration of an endoscopic medical treatment system, including a medical treatment device, according to some embodiments of the present invention;

FIG. 3 is a block diagram illustration of a medical treatment device having a protective cover, in accordance with some embodiments of the present invention.

FIG. 4 is a block diagram illustration of a medical treatment device having a protective sheath in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods and procedures have not been described in detail so as not to obscure the present invention.

According to an embodiment of the present invention, a marker for marking a medical treatment device to be inserted inside a patient's body may include one or more sealed cells or cavities, each cell or cavity may be attachable to one or more portions of the medical treatment device.

According to a further embodiment of the present invention each of the one or more sealed cells or cavities may contain a volume of gas.

Embodiments of the present invention may include focusing a detection sensor onto one or more areas of a patient's body within which a medical device may be coupled with, one or more sealed cells or cavities.

Further embodiments of the present invention may include coupling an active tip of a medical treatment device with one or more sealed cells or cavities and focusing a detection sensor (e.g. sonogram) to one or more areas of a patient's body wherein the active tip may be located.

Other embodiments of the present invention may provide a method of monitoring the path of a medical instrument inside a patient's body including coupling one or more portions of a medical treatment device with one or more sealed cells or cavities and focusing a detection sensor to one or more areas of a patient's body, within which the medical device may be located.

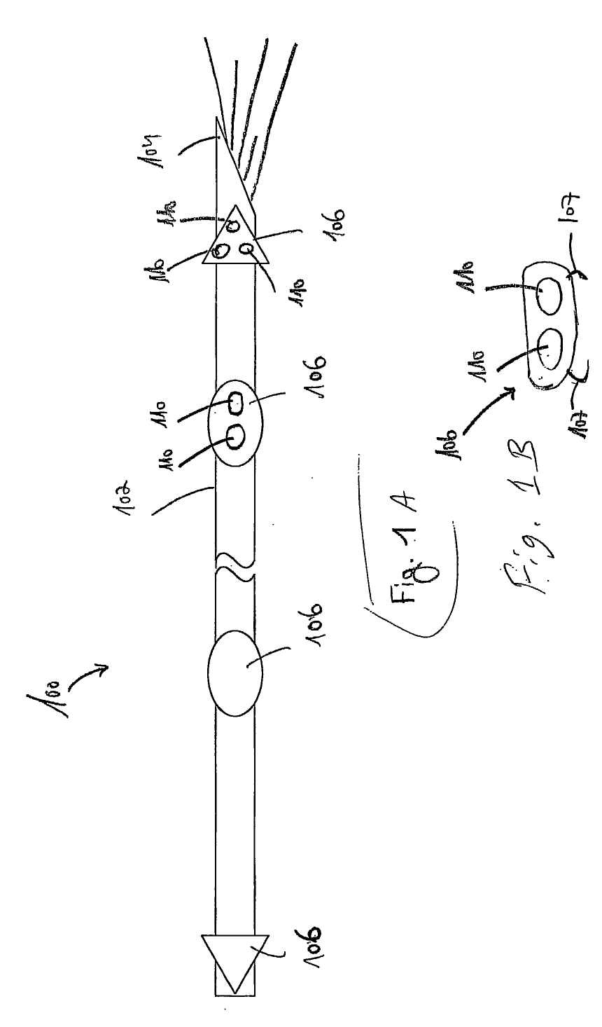

Turning now to FIG. 1A there is shown an illustration of a medical treatment device coupled with one or more markers 106, according to some embodiments of the present invention. Reference is made additionally to FIG. 1B, which is a close up view of the marker of FIG. 1A. The medical treatment device 100 may include a guidance tube 102, such as an optical fiber, an active tip 104 and one or more markers 106. Each of the one or more markers 106 may include one or more couplers 107. The couplers 107 may allow the coupling of one or more markers 106 to one or more portions of the medical treatment device 100. The couplers 107 may be any presently known or yet to be devised couplers, for example, fastening rings, adhesive and other. The markers 106 may also be fitted around one or more portions of the medical treatment device 100, for example to the marker 106 may have a ring like shape that may be fitted around a portion or portions of the medical treatment device 100. Other embodiments of the present invention may include one or markers 106 that may be embedded or partially embedded inside one or more portions of the medical treatment device 100.

The guidance tube 102 may be any presently known or yet to be devised in the future guidance tube 102 capable of transmitting energy, images or image data or conveying substances to a site of interest inside a patient's body. For example, the guidance tube may be an optical fiber, a fused silica hollow tube, plastic or rubber tubes, etc. In the embodiment shown in FIG. 1A the guidance tube 102 may be an optical fiber. The optical fiber 102 may be adapted to deliver electromagnetic energy through the active tip 104 to a treatment site inside a patient's body.

Those with ordinary skill in the art may appreciate that the medical treatment device 100 and any or all of the elements of the device 100, such as the optical fiber 102 may not be detectable inside a patient's body using conventional detectors or imagers, such as ultra-sound detectors or imagers. However, in accordance with some embodiments of the medical treatment device 100 of the present invention, when a detection sensor is focused onto one or more areas of a patient's body wherein the medical device coupled with one or more markers may be located, it may be possible to detect one or more of the markers 106.

According to some embodiments of the present invention each marker 106 may include one or more sealed cells or cavities 110. According to further embodiments, each one of the one or more sealed cells or cavities 110 may contain some volume of gas. According to yet further embodiments of the present invention, the small volume of gas may be hermetically sealed inside the one or more cells or cavities 110, such that the gas contained within the cells or cavities 110 may not escape outside the cells or cavities 110 into the surrounding environment, and vice versa.

According to further embodiments of the present invention the sealed cells or cavities 110 may be a synthetic fused silica (quartz) or any other biocompatible material. According to further embodiments of the present invention the sealed cells or cavities 110 may be transparent to ultra-sound detectors.

According to some embodiments of the present invention, the gas that may be contained in each one of the one or more cells or cavities 110, and may be selected from a group of gases that are biocompatible with living tissue or a living system. All materials, gasses used with the present invention should not be toxic or injurious and should not cause immunological rejection, for example air, CO₂, Argon and other inertic gases may be used. A group of gasses which may be avoided include gasses such as O₂, H₂ and N₂O, which may be explosive or flammable under certain conditions. However, these gasses may be used with embodiments of the medical treatment devices, if the operating conditions of these devices are safe. For example, if no excessive heat is produced during the operation of the medical treatment device, a cell or cells having O₂ contained therein may be used.

According to some embodiments of the present invention, the detectors or imagers may be adapted to detect the gas contained in each of the one or more cells or cavities 110, because the gas should have a density different that the surrounding area, a sonogram should detect the marker 106.

Each of the one or more markers 106 may be positioned anywhere along the medical treatment device 100, so long as the markers 106 do not hamper the operation of the device 100. For example, one or more markers 106 may be attached to multiple portions of an optical fiber 102, such that when the optical fiber is inserted inside a patient's body, the markers 106 may substantially provide a marking of the path of the medical treatment device 100 inside the patient's body. In another example, one or more markers may be coupled to the active tip 104 of the medical treatment device 100, marking the active tip 104. In accordance with some embodiments of the present invention, it may be possible for a user to direct the medical treatment device 100 to the desired treatment site, and to monitor the active tip 104, such that it is correctly positioned prior to the activation of the medical treatment device 100 or during the activation of such a device 100.

According to some embodiment of the present invention, the medical treatment device 100 may be used in a laparoscopy medical procedure. In laparoscopy, an optical fiber 102 may be advanced into the stomach of the patient and electromagnetic radiation may be delivered to a treatment site inside the patient's stomach. The user may use an ultra-sound imaging device to direct an ultra-sound resonance pulse onto an area of the patient's body, to detect the cells or cavities 106, to monitor the path of the optical fiber 102 inside the patient's body and direct the optical fiber 102 or the active tip 104 to the desired treatment site. Those with ordinary skill in the art may appreciate that the present invention, in combination with a variety of medical treatment devices, such as laser fibers, RF electrodes, needles and others, may be used for performing a variety of medical procedures, for example the treatment of tumors or mass of tissues like liver metastasis, uterus fibroid and other diseases.

In the embodiment shown in FIG. 1A, the optical fiber 102 is a forward-firing optical fiber wherein the active tip 104 is located at the end of the optical fiber 102. However, it should be noted that other active tip 104 designs may be used and that the invention may not be limited to a specific active tip 104. For example, a side firing optical fiber 102, such that the electromagnetic energy may be emitted sideways, may be used wherein the active tip 104 may be positioned orthogonally to the general axis of propagation of the electromagnetic radiation inside the optical fiber 102.

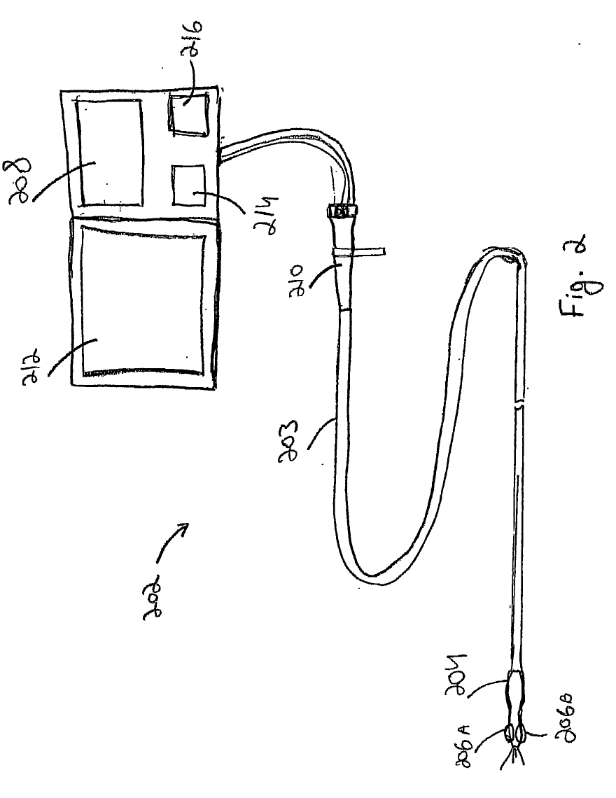

Reference is made now to FIG. 2, showing a diagram illustration of an endoscopic medical treatment system, including a medical treatment device, according to some embodiments of the present invention. The medical treatment device 202 may be insertable and advancable inside a patient's body. The medical treatment device 202 may include, for example, an optical fiber 203, an active tip 204, such as a laser probe, one or more markers 206A and 206B and a detector 208. The medical treatment device 202 may further include a handpiece 210, a display unit 212, a controller 214 and an energy source 216. The energy source 216 may be adapted to generate energy, for example, electromagnetic energy, and output that energy, for example to the optical fiber 203. The optical fiber 203 may be adapted to receive the electromagnetic energy from the energy source 216 and may be adapted to transmit the energy. The optical fiber 203 may transmit through a lumen inside a patient's body to an active tip 204. The active tip 204 may be adapted to apply or radiate the energy onto a desired treatment area or site inside the patient's body. The active tip 204 may also be adapted to manipulate or focus the energy prior to outputting the energy onto the treatment site. The active tip 204 may be adapted to substantially collimate electromagnetic energy, adjust the spot size of electromagnetic energy or beam, filter a portion of the electromagnetic energy and adjust other parameters of properties of the electromagnetic energy or beam.

It should be noted that while the active tip 204 may be a laser probe, other active tips 204 may be used with various embodiments of the present invention, including but not limited to: an optical fiber diffusive tip, laser tips, electrodes, scalpels, imagers, samplers and any other active tips, presently known or yet to be devised.

The detector 208 may include one or more transmitters (not shown) adapted to transmit one or more detection signals, one or more sensors or receivers (not shown) adapted to receive a reflected detection signal and one or more processors (not shown) that may be adapted to receive data from the reflected signal detection sensor. The transmitters may be adapted to direct the detection signal onto one or more areas of a patient's body. The processor may be adapted to process data from the reflected detection sensor, and to substantially determine the location of one or more portions of the medical treatment device 202 inside the patient's body. According to some embodiments, the detection signal may be reflected by at least one of the markers 206A and 206B. The detector 208 may be adapted to process the reflected detection sensor data to substantially determine the location of the medical treatment device inside the patient's body. The detector 208 may be adapted to process reflected detection signals that may be reflected by at least one of the markers 206A and 206B. According to some embodiments the detector 208 may process the reflected detection signal to determine the location of the portion or portions of the medical device 202 from which the detection signal was reflected, for example the detector 208 may process the reflected detection signal to determine the location of at least one of the markers 206A and 206B from which the detection signal may have been reflected. The detector 208 may be operatively connected to the display unit 212. The display unit 212 may be adapted to receive data from the detector 208. The data received by the display unit 212 may be substantially representative of the location of the portion or portions of the medical instrument 202 from which the detection signal may have been reflected, for example the display unit 212 may be input with data substantially representative of the location of at least one of the markers 206A and 206B inside the patient's body. The display unit 212 may be adapted to display one or more images substantially representative of the location of the portion or portions of the medical instrument 202 from which the detection signal may have been reflected, for example the display unit 212 may be adapted to display data substantially representative of the location of at least one of the markers 206A and 206B inside the patient's body.

The handpiece 210 may be adapted to control one or more aspects of the operation of the medical treatment device 202, for example the handpiece may be adapted to control the rate of advancement of one or more portions of the medical treatment device 202 to be inserted into the patient's body. The handpiece 210 may also be adapted to control or to allow the selection of the path through which the portion or portions of the medical treatment device 202 may be advanced, for example the handpiece 210 may control the advancement of a portion or portions of the medical treatment device 202 through a selected body lumen. The controller 214 may also be adapted to control one or more aspects of the operation of the medical treatment device 202, for example, the controller 214 may control the operation of the energy source 216. The controller may include a Digital Signal Processor (DSP) (not shown). The DSP may be adapted to process user data, data from the energy source or data from one or more sensors inside the patient's body, and to control the operation of the medical treatment device 202 in accordance with the data. The controller 214 and the headpiece 210 may be operated either in alternative or in cooperation with each other to control one or more aspects of the operation of the medical treatment device 202. The energy output of the energy source 216 may be controlled by the controller 214, however, an operator may operate the handpiece 210 to override the controller 214 and may adjust the energy output of the energy source 216.

It should be noted, that the present invention is not limited to any one particular configuration described above and that numerous other configurations, presently known or to be devised in the future may be used.

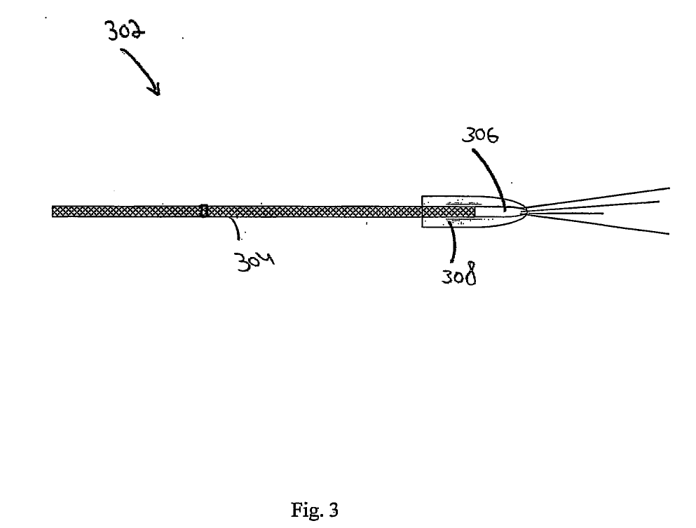

Reference is made now to FIG. 3, which is a diagram illustration of a medical treatment device having a protective cover, in accordance with some embodiments of the present invention. In the embodiment shown, the medical treatment device 302 may include an optical fiber 304, an active tip 306, such as a laser tip, and a marker 308. In the embodiment shown the marker 308 may be a sealed protective cover. The protective cover 308 may be substantially optically transparent. The sealed protective cover 308 may encapsulate a small volume of gas. In addition, the protective cover 308 may also be hermetically sealed. The optical fiber 304 may be adapted to deliver electromagnetic radiation to the active tip 306, and the active tip 306 may be adapted to emit the electromagnetic radiation onto a treatment site. The protective cover 308 may be used to protect the active tip 306 and to aid in the insertion and advancement of the medical treatment device 302 inside the patient's body, for example, the protective cover 308 may protect the active tip 306 from debris and from damage from tissue, such as hard tissue that may be located along the medical treatment device's 302 path inside the patient's body. As described above with reference to some embodiments, the hermetically sealed protective cover 308 may encapsulate in it a volume of gas. The encapsulated gas may be detectable using known imaging or detection devices, thereby allowing a user to determine the location of the protective cover 308 inside the patient's body.

According to some embodiments of the present invention the marker 308 may have a variety of shapes and dimensions. However, it may be desirable to limit the size of the marker to conform with accessibility constraints, such that the medical treatment device and the guidance element may be inserted into the patient body and advanced through a desired path, such as a cavity inside the patient's body, to the target treatment site.

Some examples of marker 308 shapes may include a capsule shaped marker coupled to a portion of the medical treatment device, a ring encircling one or more portions of the medical treatment device, or an arrow pointing to the direction of the active tip of the medical treatment device, a single marker having multiple discrete regions, and more.

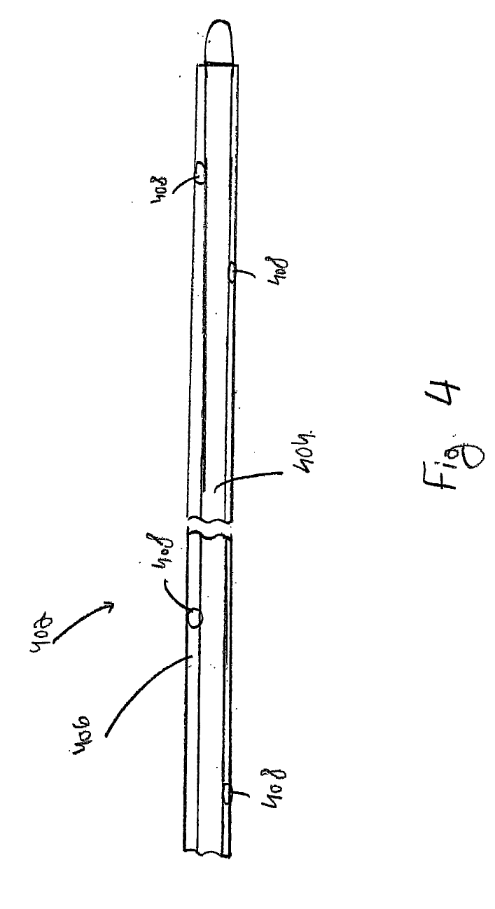

Reference is made now to FIG. 4, which is a diagram illustration of a medical treatment device having a protective sheath in accordance with some embodiments of the present invention. The medical treatment device 402 may include an optical fiber 404 and a protective or outer sheath 406, covering a substantial portion of the optical fiber 404. The medical treatment device 402 may further include one or more markers 408. Each one of the markers may include one or more sealed cells or cavities. Each one of the sealed cells or cavities may be hermetically sealed and may encapsulate some volume of gas. Each of the one or more markers 408 may be coupled to, embedded in, or fitted around the protective sheath 406, thereby marking the location of a portion or portions of the protective sheath 406. The markers 408 may be detected inside the patient's body in accordance with some embodiments of the present invetnion.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A marker for attaching to, and marking a medical treatment device to be inserted inside a patient's body, the marker comprising: one or more sealed cells.

2. The marker of claim 1, further comprising one or more coupler for coupling said markers to said medical treatment device.

3. The marker of claim 1, wherein each one of said one or more sealed cells is made of a material biocompatible with living tissue.

4. The marker of claim 1, wherein each one of said one or more sealed cells contains a volume of gas.

5. The marker of claim 4, wherein said gas is biocompatible with living tissue.

6. The marker of claim 1, wherein said one or more sealed cells are hermetically sealed.

7. The marker of claim 1, wherein at least one of said sealed cells is couplable to one or more portions of said medical treatment device to be inserted into a patient's body.

8. The marker of claim 1, wherein said one or more sealed cells and said one or more portions of said medical device, are conjointly insertable and advancable inside a patient's body.

9. The marker of claim 1, wherein at least one of said markers is couplable to an active tip of said medical instrument.

10. The marker of claim 7, wherein said one or more portions of said medical treatment device correspond to at least the path of said medical device inside the patient's body.

11. The maker of claim 7, wherein alt least one of said one or more sealed cells located inside the patient's body are detectable by a detection sensor.

12. The marker of claim 11 wherein said detection sensor is an ultra-sound resonance pulse detector.

13. A method of marking a medical treatment device to be inserted into a patient's body, the method comprising: attaching one or more markers to one or more portions of the medical device;

14. The method of claim 13, further comprising:
inserting and advancing a portion of said medical device inside a patient's body; and
focusing a detection sensor onto an area of the patient's body substantially corresponding to the location of said medical instrument inside the patient's body.

15. The method of claim 14, further comprising:
receiving a detection signal reflected from said one or more markers; and
determining the location of one or more portions of said medical device inside the patient's body.

16. A method of detecting a medical device within a patient's body, the method comprising:
directing a detection sensor to one or more areas of a patient's body wherein a medical device coupled with one or more markers is located;
detecting one or more of the markers.

17. A system for marking the location of a medical treatment device to be inserted into a patient's body, the system comprising:
a medical treatment device;
at least one marker comprising at least one sealed cell, wherein each one of said cells contains a volume of gas; and
a detector adapted to detect the marker.
